(19) United States
(12) Patent Application Publication
(10) Pub. No.: US 2017/0317400 A1
(43) Pub. Date: Nov. 2, 2017

(54) ANTENNA FOR LIGHTING CONTROL AT MESH NETWORKS NODES

(71) Applicant: GENERAL ELECTRIC COMPANY, Schenectady, NY (US)

(72) Inventor: Frantz Emmanuel ROBINSON, Lachine (CA)

(21) Appl. No.: 15/494,644

(22) Filed: Apr. 24, 2017

Related U.S. Application Data
(60) Provisional application No. 62/329,754, filed on Apr. 29, 2016.

(51) Int. Cl. H01Q 1/22; H01Q 1/38; H01Q 9/04; H01Q 15/24; H04W 84/18; H05B 37/02; F21S 8/08

(52) U.S. Cl. CPC H01Q 1/22; H01Q 15/24; H01Q 1/38; H04W 84/18; H01Q 9/0421; F21S 8/085; H05B 37/0272

(57) ABSTRACT

One exemplary embodiment provides a node for use in a mesh network. The node includes a set of printed circuit boards and a radiating element coupled to a printed circuit board of the set of printed circuit boards. The radiating element is raised above the plane of the printed circuit board.

### TECHNICAL FIELD

The present disclosure relates to antennas. More particularly, the present disclosure relates to antennas and methods of assembly thereof and for use in lighting control in mesh networks.

### BACKGROUND

With the advent of the Internet of Things (IoT), outdoor luminaires are now being included in mesh networks as a means to provide intelligent lighting control and monitoring. In such networks, each luminaire can be equipped with a node that transmits and receives data from a remote device, the data being representative either of a state of the luminaire, for example, or of a command issued to the luminaire. The remote device can be a gateway device or a remote server.

With mesh networks and IoT technologies, municipalities can actively regulate lighting output in order to efficiently illuminate public areas and roadways, for example, but they can also actively monitor power consumption and luminaire performance. As such, IoT technologies and mesh networks provide the ability to actively manage a large number of luminaires remotely, thus giving an operator the ability to save on costs and increase efficiency.

In a typical mesh network node, especially for those used in lighting applications, it may be difficult to obtain sufficient radiation performance (e.g., field uniformity, gain, efficiency, and thereby range, in the azimuthal direction and around 360 degrees) with a mesh network antenna embedded within the node, especially that the node is a system that has very restrictive constraints. For example, and not by limitation, such constraints may include the need to fit the mesh network antenna in a very compact and crowded enclosure with limited available lateral space and/or height, and/or in an enclosure including several closely spaced printed circuit boards (PCBs). Another constraint may be the need to co-locate the mesh network antenna with other hardware, such global position system (GPS) antennas and/or transceivers. Moreover, the mesh network antenna must have high tolerance to locally generated electromagnetic (EM) interference. Furthermore, other constraints can include cost, and ease, consistency, and quality of manufacturing.

Several mesh network antenna configurations have sought to mitigate these constraints. For example, a typical configuration can include a centrally-located wire helical (i.e., a normal mode) antenna that is approximately 50 millimeters (mm) high. While this configuration performs well in terms of radio frequency performance, it requires manual soldering and thus suffers from several issues in manufacturing consistency. As such, the performance metrics of these antennas varies greatly based on slight variations in placement and tolerances, thereby yielding large variations in tuning.

### SUMMARY

The embodiments featured herein help solve or mitigate the above noted issues as well as other issues known in the art. For example, and not by limitation, the embodiments feature herein can achieve a lower cost target and ease on the cost of manufacturing. Specifically, the embodiments provide satisfactory radiation performance without being difficult to manufacture as described above for typical configuration.

Additionally, as the embodiments can be used in outdoor applications, the typical problems of wet weather or similar phenomena causing de-tuning effects to the antenna in typical antennas are circumvented, which increases system performance.

One exemplary embodiment provides a node for use in a mesh network. The node includes a set of printed circuit boards and a radiating element coupled to a printed circuit board of the set of printed circuit boards. The radiating element is raised above the plane of the printed circuit board.

Another exemplary embodiment provides a node assembly for use in a luminaire mesh network. The node assembly includes a set of printed circuit boards including at least two stacked printed circuit boards. Furthermore, the node assembly includes an antenna disposed on one of the at least two stacked printed circuit boards, the antenna including at least one element elevated with respect to a plane of the one of the at least two stacked printed circuit boards.

Another exemplary embodiment provides a node assembly for use in a luminaire mesh network. The node assembly includes a set of printed circuit boards including at least two stacked printed circuit boards. Further, the node assembly includes a set of antennas. Each antenna in the set of antennas is disposed on one of the at least two stacked printed circuit boards. Furthermore, each antenna in the set of antennas includes at least one element elevated with respect to a plane of the one of the at least two stacked printed circuit boards.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1A illustrates an antenna without a host printed circuit board, according to an embodiment.

FIG. 1B illustrates a view from above a typical street lighting fixture.

FIG. 2 illustrates a back side view of an antenna in accordance with several aspects described herein.

FIG. 3 illustrates a node in accordance with several aspects described herein.

FIG. 4 illustrates a node in accordance with several aspects described herein.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

Typical small surface mount antennas suffer from poor efficiency resulting from distorted and asymmetrical radiation patterns due to their proximity to PCBs and other components. Further, they have narrow bandwidth due to their small “electrical” size. In the embodiments, the antenna's radiating element is raised above the plane of the device's upper PCB allows it to achieve much higher efficiency and field uniformity. The vertical orientation of the antenna allows it to make much better use of available space to provide a larger “electrical” antenna effect (effectively ¼ wavelength) and has been optimized to provide much better (wider) bandwidth as a result.

Small surface mount (SMT) antennas typically found in lighting control mesh network nodes can suffer from poor efficiency, i.e., they may have a distorted and/or asymmetrical radiation pattern due to the proximity of the antennas to the PCBs located in the node. Additionally, these antennas may narrow bandwidth due to their small “electrical” size. Furthermore, a typical SMT antenna can also suffers from a high susceptibility to EM interference, especially to interference emanating from below its position relative to the PCB. This is partly due to the antenna's requirement of a large non-metalized opening in the PCB.

In contrast to typical SMT antennas, antennas implemented according to some of the embodiments circumvent the aforementioned shortcomings by being mated to a PCB which provides a solid unbroken ground plane. The PCB thus acts as a counterpoise and augments the antenna's performance while effectively shielding the antenna from EM emissions originating from below.

Furthermore, according to the embodiments, raising the antenna's radiating element above the plane of the node's upper PCB allows it to achieve much higher efficiency and field uniformity. Such a vertical orientation of the antenna allows it to make much better use of available space to provide a larger “electrical” antenna effect (i.e., effectively providing a ¼ wavelength antenna) and which leads to an improved (i.e., wider) bandwidth with respect typical SMT antennas.

Antennas implemented according to the embodiments can be inverted F/half-slot antennas, making them ideal for lighting control in mesh networks. Further, the exemplary antennas can be made to fit at a relatively low profile (e.g., ˜18 mm height) while still maintaining the required vertical polarization, along with the aforementioned performance features, in contrast to other vertical polarization antenna designs commonly seen, such as the typically-used vertical ¼-wave monopole or helical antennas.

Antennas implemented according to the embodiments are extremely low cost compared to typical SMT antennas because they can be made of commodity-grade FR-4 PCB material, which can be sourced from any PCB manufacturer. As such, the embodiments achieve ease of manufacture, consistency, quality, and low cost of assembly in addition to high performance. Furthermore, antennas implemented according to embodiments can be installed via a normal SMD reflow soldering process, simultaneously with other components on the PCB, thereby further providing ease of integration and assembly.

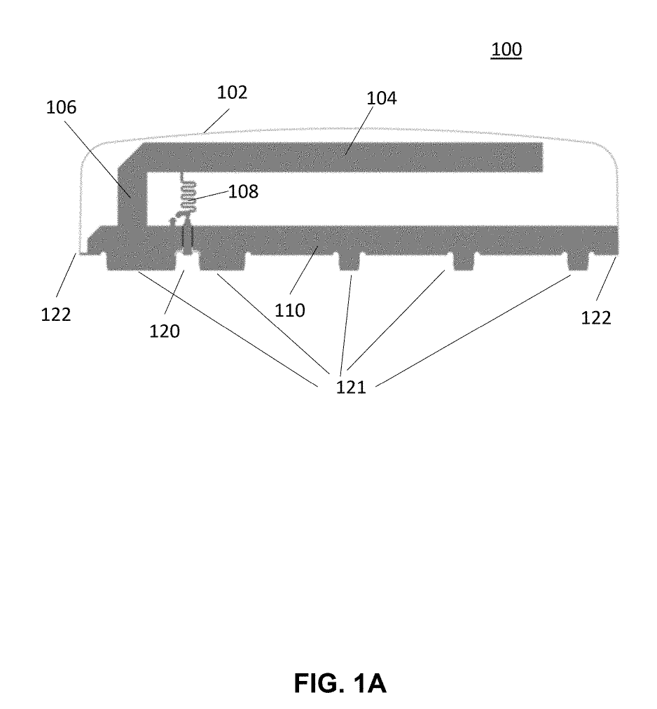

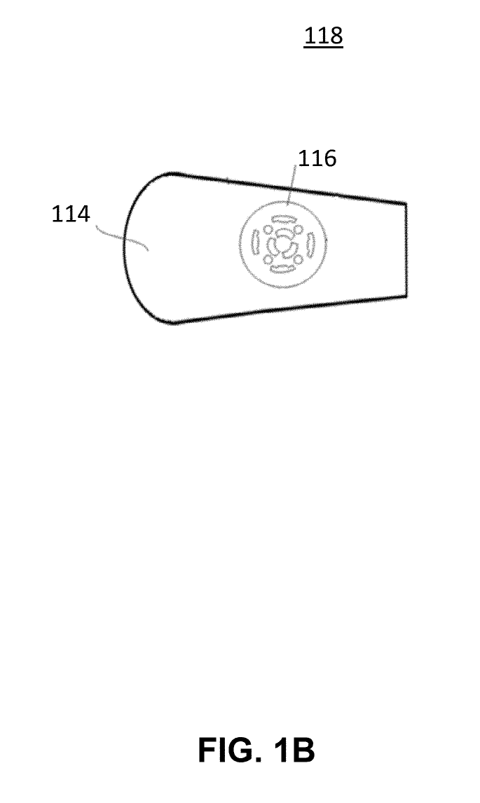

FIG. 1A illustrates an exemplary antenna 100 without a host PCB. The antenna 100 with an outline surface 102, and the antenna 100 includes an antenna mounting surface 102 which can touch the top surface 122 of a host PCB once mounted thereto. The antenna 100 further includes radiating elements 104 and 106, which can each be made of a conductive trace or of a conductive material. The antenna 100 further includes a feed matching element 108, and an antenna feed input pad or pin 120 that mates directly with the host PCB. The antenna 100 further includes a raised ground reference surface 110 which serves as a counterpoise for the antenna radiating elements 104 and 106. Lastly, the antenna 100 includes through-hole teeth 121 that provide rigid mechanical support and a uniform ground reference connection.

FIG. 1B shows a view 118 from above a typical street lighting fixture 114 having a control node socket 116 through which a node including the antenna 100 can fit. While the street lighting fixture 114 is shown to have a particular shape, one of skill in the art will readily understand that the present disclosure is not limited to such shapes and ca be extend to other types of light fixtures.

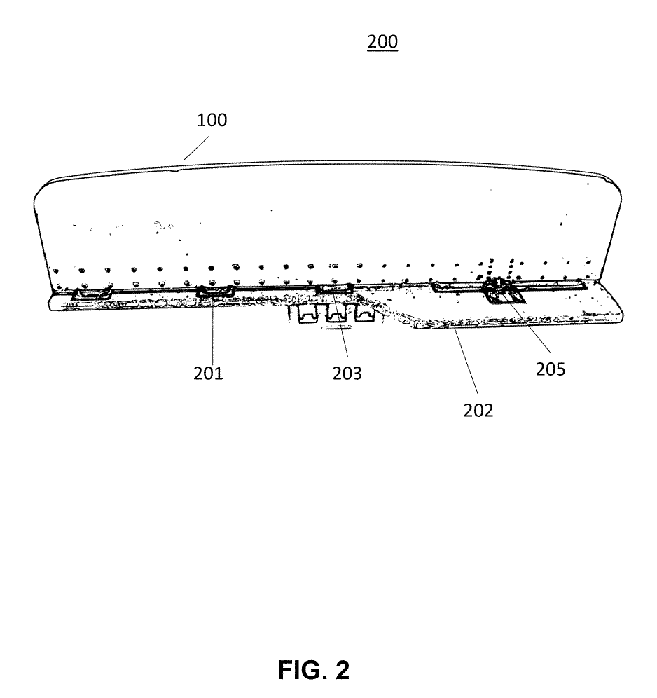

FIG. 2 illustrates a back side view 200 of the exemplary antenna 100 when it is mounted on a host PCB 202. As shown, the antenna 100 is mounted a position such that it is raised above the plane of the host PCB 202 and orthogonal to the plane of the host PCB 202. FIG. 2 further depicts the detail of the mounting/ground solder joints 201 and 205 and the antenna feed line solder joint (SMT) 203. In this embodiment, the antenna 100 utilizes an SMD feedline joint to minimize the parasitic/detuning effects of the joints. In alternate embodiments, a through-hole joint could also be used. Furthermore, one advantage of the antenna 100 is that it allows for “pin-in-paste” mounting to be used as part of the normal SMD component reflow soldering process, all in a single pass in a reflow oven, which minimizes assembly costs.

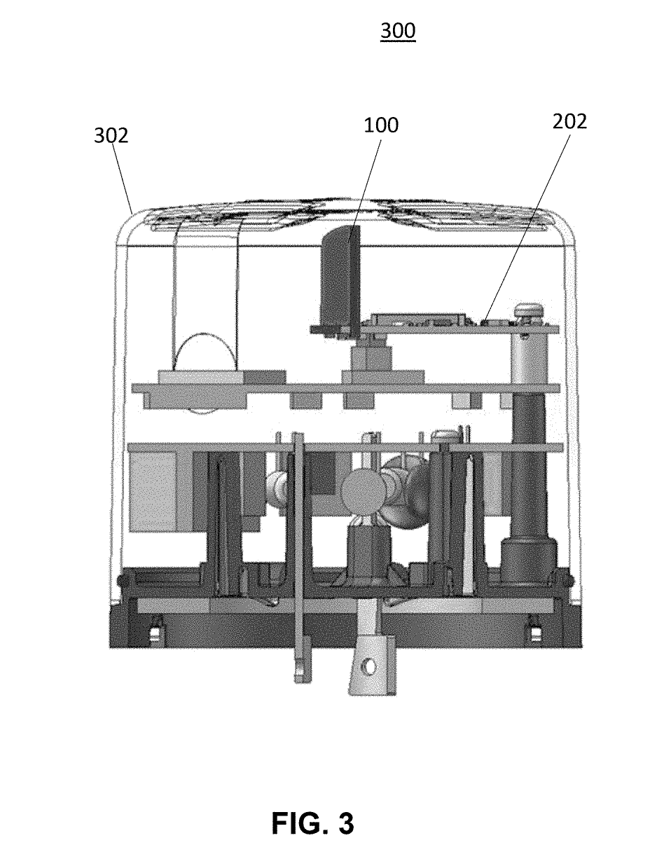

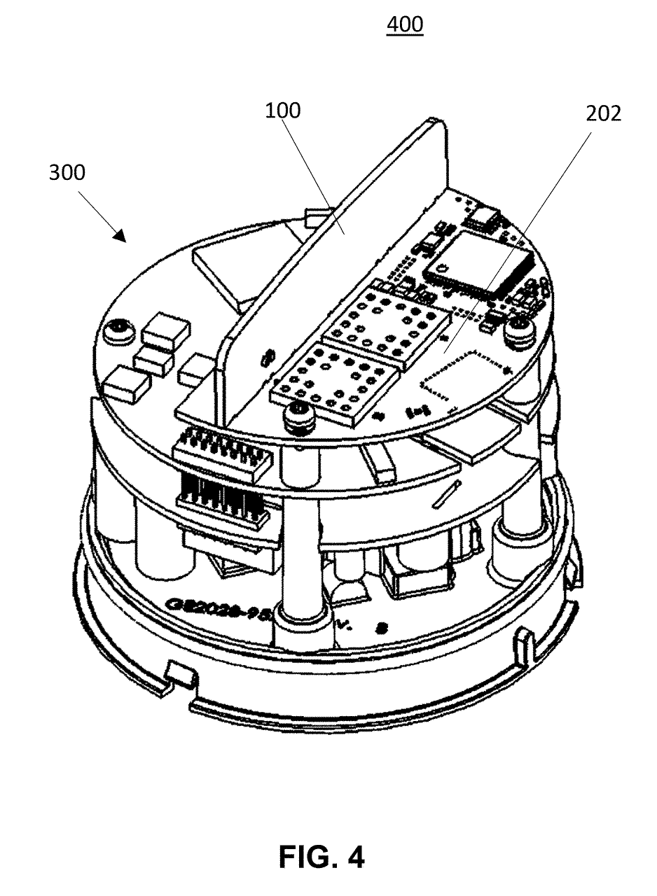

FIG. 3 illustrates a cross-sectional view of a node 300, which is assembled of interfacing with a street luminaire such as the lighting fixture 114. The node 300 includes the antenna 100, which is disposed on the host PCB 202 as discussed above. The node 300 further includes a plastic cover or an antenna radome 302 that protect the circuits inside the node from the ambient environment in addition to providing additional radiative functionality to the antenna 100. FIG. 4 illustrates a perspective view 400 of the node 300, without the plastic cover or antenna radome 302.

The embodiments confer several advantages that are readily appreciable by one of skill in the art. For example, and not by limitation, in some of the embodiments, primary antenna performance parameters are significantly superior to typical antennas for meshed nodes. Therefore, antennas according to the embodiments have greater range and thus provide more robust and reliable communication links. Further, in some of the embodiments, there are no external matching components, a feature which reduces installation cost and improves quality and consistency in manufacturing. In addition, the antennas are resistant to detuning effects that can be caused by the human body and by wet weather. The embodiments also feature antennas that can be mounted via a standard SMD reflow soldering process, thereby providing additional cost savings.

For contexts different than mesh network node applications, (i.e., in applications where height and other constraints and performance objectives are different than those of mesh network nodes), alternate embodiments can achieve similar or even better performance, using several discrete antennas that are symmetrically embedded or placed around the main horizontal PCB edge. In these embodiments, an “antenna diversity” arrangement is used to recover a more uniform effective total antenna field pattern and directional gain.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A node for use in a mesh network, comprising:
a set of printed circuit boards, and
a radiating element coupled to a printed circuit board of the set of printed circuit boards;
wherein the radiating element is raised above the plane of the printed circuit board.

2. The node of claim 1, wherein the printed circuit board is disposed farthest away from the base of the node.

3. The node of claim 2, wherein the base is adapted to couple to a dorsal portion of a luminaire.

4. The node of claim 1, wherein the radiating element is included in an antenna.

5. The node of claim 4, wherein the antenna is an inverted F/half slot antenna.

6. The node of claim 4, wherein the antenna is configured for mesh networking.

7. The node of claim 4, wherein the antenna includes an FR-4 PCB material.

8. The node of claim 1, wherein the radiating element is configured to provide a vertical polarization of an electromagnetic wave emanating from the radiating element.

9. The node of claim 1, wherein the radiating element is disposed about 18 mm above the printed circuit board.

10. A node assembly for use in a luminaire mesh network, the node assembly comprising:
a set of printed circuit boards including at least two stacked printed circuit boards; and
an antenna disposed on one of the at least two stacked printed circuit boards, the antenna including at least one element elevated with respect to a plane of the one of the at least two stacked printed circuit boards.

11. The node assembly of claim 10, wherein the one of the at least two stacked printed circuit board is disposed farthest away from a dorsal portion of a luminaire when a node including the node assembly is mounted on the luminaire.

12. The node assembly of claim 10, wherein the antenna includes a radiating element configured to provide a vertical polarization of an electromagnetic wave emanating from the radiating element.

13. The node assembly of claim 10, wherein the antenna is a 1/F half-slot antenna.

14. The node assembly of claim 10, wherein the at least one element is disposed about 18 mm away from the plane.

15. The node assembly of claim 10, wherein the antenna is co-located with at least one other antenna.

16. The node assembly of claim 10, wherein the antenna is co-located with at least one transceiver.

17. The node assembly of claim 10, wherein the antenna is configured for mesh network communications.

18. A node assembly for use in a luminaire mesh network, the node assembly comprising:
a set of printed circuit boards including at least two stacked printed circuit boards; and
a set of antennas, wherein each antenna in the set of antennas is disposed on one of the at least two stacked printed circuit boards, and
wherein each antenna in the set of antennas includes at least one element elevated with respect to a plane of the one of the at least two stacked printed circuit boards.

19. The node assembly of claim 18, wherein each antenna in the set of antennas is a 1/F half-slot antenna.

20. The node assembly of claim 18, wherein each antenna in the set of antennas includes at least one radiating element disposed about 18 mm away from the plane.
